(19) United States
(12) Patent Application Publication
(10) Pub. No.: US 2012/0139852 A1
(43) Pub. Date: Jun. 7, 2012

(54) TOUCH PANEL AND TOUCH DISPLAY PANEL HAVING THE SAME

(75) Inventors: Shin-Chieh Huang, Taichung City (TW); Ming-Kung Wu, Taichung County (TW); Ping-Wen Huang, Taichung City (TW); Hsing-Yu Liu, Taichung County (TW)

(73) Assignees: WINTEK CORPORATION, Taichung (TW); Wintek Technology (H.K) Ltd., Dongguan (CN)

(21) Appl. No.: 13/226,439

(22) Filed: Sep. 6, 2011

(30) Foreign Application Priority Data
Dec. 1, 2010 (TW) 99141796

(51) Int. Cl. G06F 3/041

(52) U.S. Cl. 345/173

(57) ABSTRACT

A touch panel and a touch display panel having the same are provided. The touch panel includes a cover plate, a decoration layer, a plurality of first sensing series, a plurality of second sensing series, and a plurality of third sensing series. The cover plate has a display area and a non-display area surrounding the display area. The decoration layer is disposed on the non-display area of the cover plate. Each of the first sensing series includes a plurality of first sensing pads, a plurality of display-area first bridge lines, and a plurality of non display-area first bridge lines. The display-area first bridge lines bridge the first sensing pads located in the display area in a first direction. The non display-area first bridge lines bridge the first sensing pads located in the non-display area in the first direction, wherein the material of the non display-area first bridge lines is metal.

### CROSS-REFERENCE TO RELATED APPLICATION

This application claims the priority benefit of Taiwan application serial No. 99141796, filed on Dec. 1, 2010. The entirety of the above-mentioned patent application is hereby incorporated by reference herein and made a part of this specification.

### BACKGROUND OF THE INVENTION 1. Field of the Invention

The invention relates to a touch panel and a touch display panel, and more particularly to a touch panel and a touch display panel on a cover plate, wherein the touch panel and the touch display panel are disposed with icons.

2. Description of Related Art

Referring to FIG. 1, a touch panel 100 has a display area 102 and a non-display area 104 that surrounds the display area 102. The display area 102 is disposed with a plurality of sensing series 112 and 114. In addition, in order to provide a fixed key function, the non-display area 104 usually is disposed with a plurality of button icons 120.

As shown in FIG. 1, each button icon 120 is respectively connected to a circuit of a driving chip (not shown) through a transmission line 122 to sense if the location of the button icon 120 has been touched, in order to execute the desired function. Each sensing series 112 or 114 is connected to the circuit of the driving chip (not shown) through a transmission line 116 to proceed with a touch sensing function. As such, a specific driving chip (not shown) must be used in order to respectively proceed with sensing towards components with different arrangement methods (i.e. button icon 120 and sensing series 112, 114).

### SUMMARY OF THE INVENTION

The invention relates to a touch panel, wherein a display area and a non-display area possess touch-sensing components with similar arrangements to avoid limitations when using a driving chip. A plurality of sensing series located in the non-display area are made to having bridge lines with metal, to lower the overall impedance of the sensing series.

The invention provides a touch panel, including a cover plate, a decoration layer, a plurality of first sensing series, a plurality of second sensing series, and a plurality of third sensing series. The cover plate has a display area and a non-display area, and the non-display area surrounds the display area. The decoration layer is disposed on the non-display area, and the decoration layer has at least one icon. The first sensing series is disposed on the cover plate and the decoration layer. Each of the first sensing series includes a plurality of first sensing pads, a plurality of display-area first bridge lines, and a plurality of non-display area first bridge lines. The first sensing pads are arranged in parallel along a first direction, wherein a portion of the first sensing pads are disposed in the display area, and the other portion of the first sensing pads are disposed in the non-display area, wherein the other portion of the first sensing pads at least corresponds to the position of the icons located in the decoration layer.

The display-area first bridge lines bridge the first sensing pads located in the display area along the first direction. The plurality of non-display area first bridge lines bridge the first sensing pads located in the non-display area along the first direction. A material of the non-display area first bridge lines is metal. The second sensing series are disposed in the display area of the cover plate. Each of the second sensing series extends along a second direction, and the first direction is not parallel to the second direction. The third sensing series are disposed in the non-display area of the cover plate, and each of the third sensing series extends along the second direction.

The invention further provides a touch display panel including the touch panel disclosed above, and a display panel. The display panel is disposed on a side of the cover plate disposing with the decoration layer.

Based on the above, the display area and the non-display area of the cover plate according to the invention both adopt sensing series as touch-sensing components. Thus, a driving chip for the touch panel is not required to have two types of sensing functions. This way, the driving chip type can be further diversified. In addition, the sensing series in the non-display area according to the invention adopts metal bridge lines, which help in lowering the impendence of the sensing series to satisfy the needs of the driving chip.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic view of a conventional touch panel.

FIG. 2 is a schematic view of a touch panel according to an embodiment of the invention.

FIGS. 3 through 6 are cross-sectional structural views of the touch panel in FIG. 2 along a line I-I′ implemented with multiple methods.

FIG. 7 is a schematic view of a touch display panel according to an embodiment of the invention.

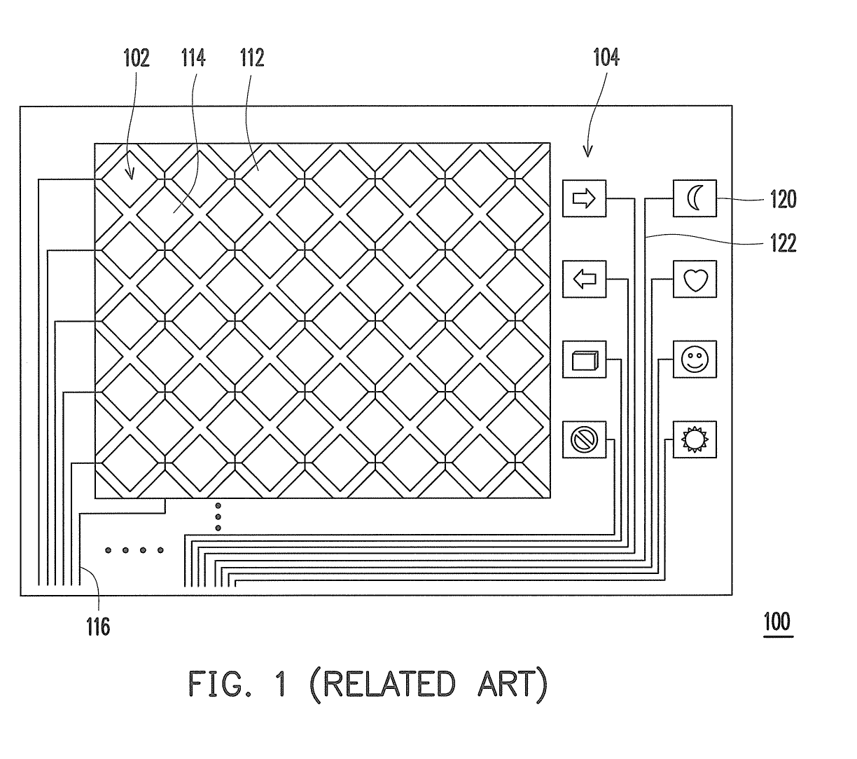

### DESCRIPTION OF EMBODIMENTS

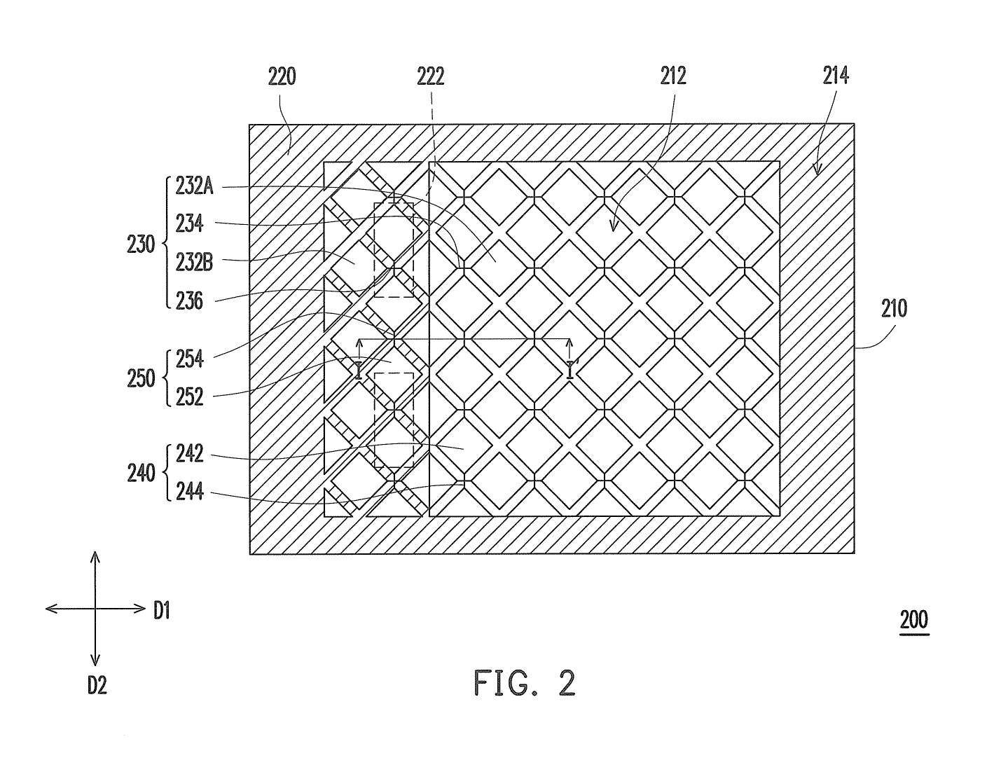

Referring to FIG. 2, the touch panel 200 includes a cover plate 210, a decoration layer 220, a plurality of first sensing series 230, a plurality of second sensing series 240, and a plurality of third sensing series 250. Each of the first sensing series 230, each of the second sensing series 240, and each of the third sensing series 250 are mutually separated from each other. The cover plate 210 has a display area 212 and a non-display area 214, and the non-display area 214 surrounds the display area 212. The decoration layer 220 is disposed on the non-display area 214 of the cover plate 210, and the decoration layer 220 includes at least one icon 222. FIG. 2 shows two icons 222 as an example, however, the invention does not limit the number of icons 222. The first sensing series 230 are disposed on the cover plate 210 and the decoration layer 220, and each of the first sensing series 230 extends along a first direction D1. The second sensing series 240 are disposed in the display area 212 of the cover plate 210.

Each of the second sensing series 240 extends along a second direction D2, and the first direction D1 is not parallel to the second direction D2. The first direction D1 can be perpendicular to the second direction D2. In addition, the third sensing series 250 are disposed in the non-display area 214 of the cover plate 210, and each of the third sensing series 250 extends along the second direction D2.

Each of the first sensing series 230 extends to the non-display area 214 through the display area 212, and has a portion disposed on the location of the icon 222. In addition, each of the first sensing series 230 includes a plurality of first sensing pads 232A, 232B, a plurality of display-area first bridge lines 234, and a plurality of non-display area first bridge lines 236. The display-area first bridge lines 234 bridge the first sensing pads 232A located in the display area 212 along the first direction D1, and the non-display area first bridge lines 236 bridge the first sensing pads 232B located in the non-display area 214 along the first direction D1.

The decoration layer 220 can be made of transparent or opaque material. The opaque material is, for example, ink, ceramic, diamond-like carbon (DLC), or photo resist material. A material of the non-display area first bridge lines 236 is metal, so as to raise the transmission characteristics of the non-display area first bridge lines 236, and lower the impedance of each first sensing series 230. This way, even if, in the structural arrangement, there is an increase in length in the first sensing series 230 that extends to the non-display area 214 through the display area 212, it is difficult to cause a condition where the driving chip (not shown) can not be matched resulting from the impedance being too high.

In the embodiment, a portion of the first sensing series 230 and the third sensing series 250 are disposed in the non-display area 214 as sensing components used to determine if the user has touched the icon 222. Thus, the driving chip (not shown) of the touch panel 200 adopts merely one sensing mode that can proceed with touch sensing towards different areas, and help simplify the design of the driving chip.

Each of the second sensing series 240 of the embodiment includes a plurality of second sensing pads 242 and a plurality of second bridge lines 244. The second bridge lines 244 serially connect the second sensing pads 242 along the second direction D2. Each of the third sensing series 250 includes a plurality of third sensing pads 252 and a plurality of third bridge lines 254. The third bridge lines 254 serially connect the third sensing pads 252 along the second direction D2.

In the embodiment, the non-display area 214 can adopt metal as bridge lines (for example 236 and 254) to lower the impedance of the sensing series (230, 250). Thus, the sensing series (230, 250) can achieve good matching with the driving chip (not shown) used to drive the touch panel 200, without exceeding the load of the driving chip. In addition, components in the display area 212, for example the first sensing pads 232A, the display-area first bridge lines 234, and the second sensing series 240, can adopt indium tin oxide, indium zinc oxide, or other transparent conductive materials for fabrication. Thus, the touch panel 200 in the display area 212 can have ideal light transmittance.

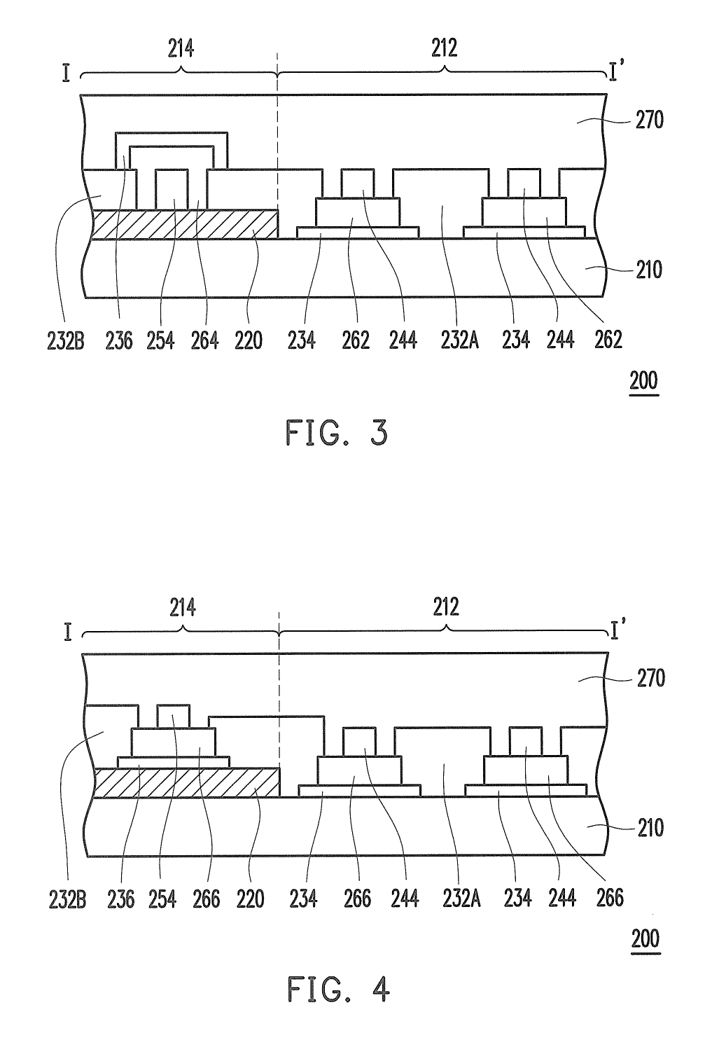

In the touch panel 200, the sensing series 230, 240, and 250 can adopt different fabrication orders, and the cross-sectional structure can change along with the change in fabrication order. Thus, the plurality of different cross-sectional structures of the touch panel 200 under different fabrication orders will be elaborated hereinafter with reference to the drawings. In other words, FIGS. 3 through 6 are cross-sectional structural views of the touch panel in FIG. 2 along a line I-I′ implemented with multiple methods.

Referring to both FIGS. 2 and 3, the touch panel 200, for example, is fabricated through the following steps. First, the decoration layer 220 is foamed on the cover plate 210. Accordingly, the display area 212 and the non-display area 214 are clearly divided. Next, the transparent display-area first bridge lines 234 are disposed on the display area 212 of the cover plate 210, and as shown in FIG. 2, the display-area first bridge lines 234 are arranged along the first direction D1.

Then, first insulating patterns 262 are formed on the display-area first bridge lines 234. Each of the first insulating patterns 262 are disposed on each of the display-area first bridge lines 234 of the display area 212, and the first insulating patterns 262 expose at least the two ends of each display-area first bridge line 234.

Afterwards, the first sensing pads 232A, 232B, the second sensing series 240, and the third sensing series 250 are formed with transparent conductive material, wherein only the second bridge lines 244 of the second sensing series 240 and the third bridge lines 254 of the third sensing series 250 are shown in FIG. 3. Now, the two ends of each display-area first bridge line 234 exposed by the first insulating patterns 262 can make contact with the first sensing pads 232A. In the embodiment, the first sensing pads 232A, 232B, the second sensing series 240, and the third sensing series 250 can be fabricated simultaneously with the same layer, but the invention is not limited thereto.

Following, the second insulating patterns 264 are formed on the third bridge lines 254, and a metal material is formed on the second insulating patterns 264 to constitute the non-display area first bridge lines 236, wherein the non-display area first bridge lines 236 traverse the second insulating patterns 264 to connect two adjacent first sensing pads 232B. Then, a protective layer 270 is formed on the cover plate 210, covering the first sensing series 230, the second sensing series 240, and the third sensing series 250.

In another embodiment, referring to both FIGS. 2 and 4, the touch panel 200, for example, is fabricated through the following steps. First, the decoration layer 220 is formed on the cover plate 210. Then, the non-display area first bridge lines 236 are formed on the decoration layer 220 with metal material, and the display-area first bridge lines 234 are formed on the cover plate 210 with transparent conductive material. The non-display area first bridge lines 236 and the display-area first bridge lines 234 are arranged along the first direction D1.

Next, a plurality of insulating patterns 266 are formed on each of the display-area first bridge lines 234 and the non-display area first bridge lines 236. These insulating patterns 266 expose the two ends of each display-area first bridge lines 234 and the two ends of each non-display area first bridge lines 236. Afterwards, the first sensing pads 232A, 232B, the second sensing series 240, and the third sensing series 250 are formed with transparent conductive material on the cover plate 210, wherein FIG. 4 only shows the second bridge lines 244 of the second sensing series 240 and the third bridge lines 254 of the third sensing series 250 . Thereafter, a complete protective layer 270 is formed on the cover plate 210, covering all the sensing series (230, 240, 250).

As seen in the embodiment shown in FIG. 4, the display-area first bridge lines 234 and the non-display area first bridge lines 236 of the first sensing series 230 are disposed between the first sensing pads 232A, 232B and the cover plate 210. The third bridge lines 254 can be selectively formed by metal material in another fabrication process.

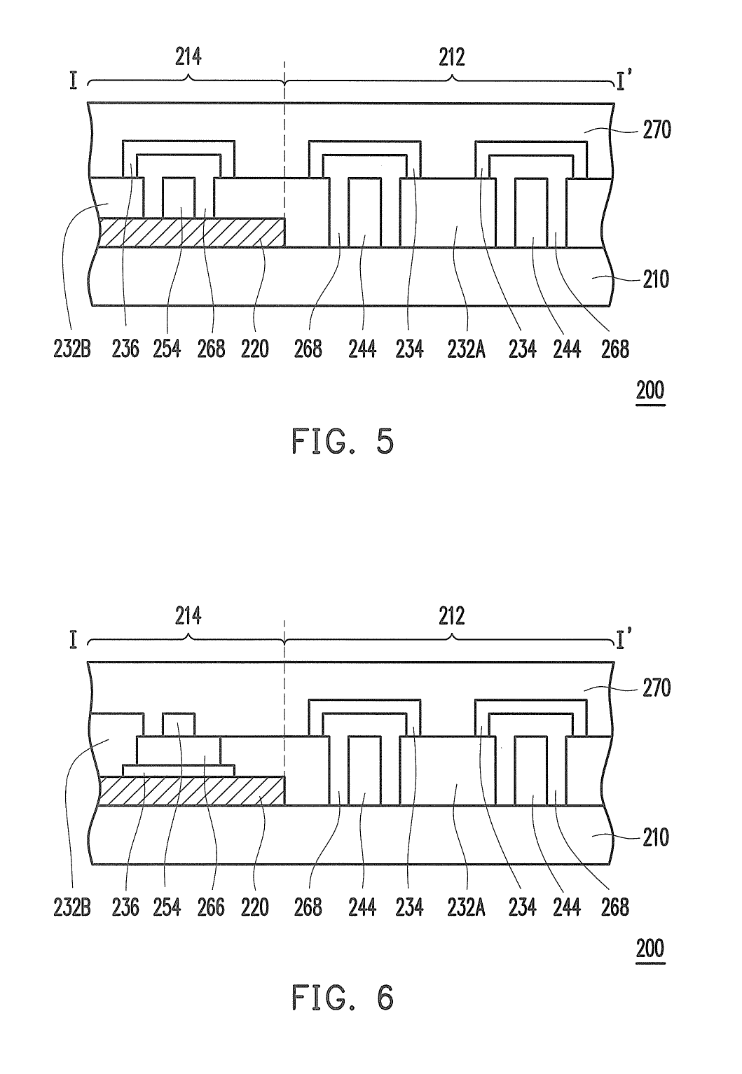

Referring to FIGS. 2 and 5, the fabrication method of the touch panel 200 can be: firstly forming the first sensing pads 232A, 232B, the second sensing series 240, and the third sensing series 250 with transparent conductive material on the cover plate 210 which is disposed with the decoration layer 220, wherein FIG. 5 only shows the second bridge lines 244 of the second sensing series 240 and the third bridge lines 254 of the third sensing series 250.

Next, insulating patterns 268 are formed on each of the second bridge lines 244 and the third bridge lines 254. Now, an insulating pattern 268 is disposed between two adjacent first sensing pads 232A and between two adjacent first sensing pads 232B. The non-display area first bridge lines 236 are then formed on a portion of the insulating pattern 268 with metal material, and the display-area first bridge lines 234 are formed on the other portion of the insulating pattern 268 with transparent conductive material. Thereafter, a complete protective layer 270 is formed on the cover plate 210, covering all the sensing series (230, 240, 250).

In addition, please refer to both FIG. 2 and FIG. 6. In the fabrication method of the touch panel 200, the non-display area first bridge lines 236 can be first formed with metal material on the decoration layer 220, wherein the decoration layer 220 is disposed on the cover plate 210. Next, the first sensing pads 232A, 232B and the second sensing series 240 are formed with transparent conductive material, wherein FIG. 5 just shows the second bridge lines 244 of the second sensing series 240.

Then, an insulating pattern 268 and an insulating pattern 266 are formed on each of the second bridge lines 244 and the non-display area first bridge lines 236, respectively. The third bridge lines 254 of the third sensing series 250 are formed in the non-display area 214 of the insulating pattern 266 with metal material, and the display-area first bridge lines 234 are formed in the display area 212 with transparent conductive material. Thereafter, a complete protective layer 270 is formed on the cover plate 210, covering all the sensing series (230, 240, 250).

The aforementioned insulating patterns 262, 264, 266, 268 of the embodiment can be island patterns patterned from an insulating layer. However, the insulating patterns 262, 264, 266, 268 can be replaced respectively by an insulating layer having a plurality of openings. That is to say, the invention does not specifically limit the insulating structural design as island patterns, as long as the intersecting bridge lines are designed to be electrically insulated from each other, the design can be applied to the touch panel 200.

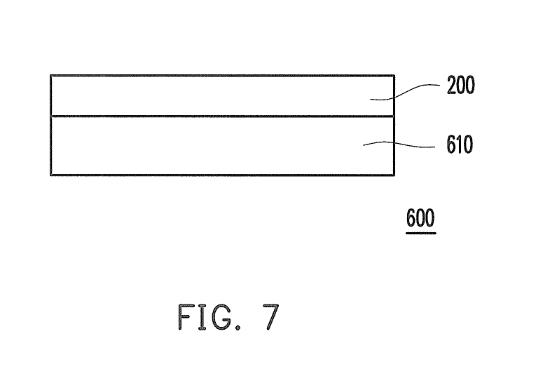

FIG. 7 is a schematic view of a touch display panel according to an embodiment of the invention. Referring to FIG. 2 and FIG. 7 together, a touch display panel 600 includes the touch panel 200 depicted in FIG. 2 and a display panel 610. The display panel 610 is disposed on a side of the cover plate 210 disposing the decoration layer 220. The display panel 210 is a liquid crystal display (LCD) panel, an organic luminescent display panel, an electronic paper display panel, an electrophoretic display panel, an electrowetting display panel, a bi-stable display panel, or a plasma display panel.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A touch panel, comprising:
a cover plate, having a display area and a non-display area, and the non-display area surrounding the display area;
a decoration layer, disposed on the non-display area, and the decoration layer has at least one icon;
a plurality of first sensing series, disposed on the cover plate and the decoration layer, each of the first sensing series comprises:
a plurality of first sensing pads, arranged in parallel along a first direction, a portion of the first sensing pads are disposed in the display area, and the other portion of the first sensing pads are disposed in the non-display area, and the other portion of the first sensing pads at least corresponds to the position of the icons located on the decoration layer;
a plurality of display-area first bridge lines, the display-area first bridge lines bridging the first sensing pads located in the display area along the first direction;
a plurality of non-display area first bridge lines, the non-display area first bridge lines bridging the first sensing pads located in the non-display area along the first direction, a material of the non-display area first bridge lines is metal;
a plurality of second sensing series, disposed in the display area of the cover plate, each of the second sensing series extend along a second direction, and the first direction is not parallel to the second direction; and
a plurality of third sensing series, disposed in the non-display area of the cover plate, each of the third sensing series extend along the second direction, and each of the first sensing series, each of the second sensing series, and each of the third sensing series are mutually spaced from each other.

2. The touch panel as claimed in claim 1, wherein a material of the display-area first bridge lines of each of the first sensing series is a transparent conductive material.

3. The touch panel as claimed in claim 1, wherein the second sensing series includes a plurality of second sensing pads and a plurality of second bridge lines, the second bridge lines bridge the second sensing pads along the second direction, and a material of the second bridge lines is a transparent conductive material.

4. The touch panel as claimed in claim 1, wherein the third sensing series includes a plurality of third sensing pads and a plurality of third bridge lines, the third bridge lines bridge the third sensing pads along the second direction, and a material of the second bridge lines is metal.

5. The touch panel as claimed in claim 1, wherein the display-area first bridge lines, the first sensing pads, and the non-display area first bridge lines of each of the first sensing series are sequentially disposed outwardly from the cover plate.

6. The touch panel as claimed in claim 1, wherein the display-area first bridge lines and the non-display area first bridge lines of each of the first sensing series are disposed between the first sensing pads and the cover plate.

7. The touch panel as claimed in claim 1, wherein the display-area first bridge lines and the non-display area first bridge lines of each of the first sensing series are disposed on a side of the first sensing pads away from the cover plate.

8. The touch panel as claimed in claim 1, further comprising a protective layer, covering the first sensing series, the second sensing series, and the third sensing series.

9. A touch display panel, comprising:
a touch panel, comprising:
a cover plate, having a display area and a non-display area, and the non-display area surrounding the display area;
a decoration layer, disposed on the non-display area, and the decoration layer has at least one icon;
a plurality of first sensing series, disposed on the cover plate and the decoration layer, each of the first sensing series comprises:
a plurality of first sensing pads, arranged in parallel along a first direction, a portion of the first sensing pads are disposed in the display area, and the other portion of the first sensing pads are disposed in the non-display area, and the other portion of the first sensing pads at least corresponds to the position of the icons located on the decoration layer;
a plurality of display-area first bridge lines, the display-area first bridge lines bridging the first sensing pads located in the display area along the first direction;
a plurality of non-display area first bridge lines, the non-display area first bridge lines bridging the first sensing pads located in the non-display area along the first direction, a material of the non-display area first bridge lines is metal;
a plurality of second sensing series, disposed in the display area of the cover plate, each of the second sensing series extend along a second direction, and the first direction is not parallel to the second direction;
a plurality of third sensing series, disposed in the non-display area of the cover plate, each of the third sensing series extend along the second direction, and each of the first sensing series, each of the second sensing series, and each of the third sensing series are mutually spaced from each other; and
a display panel, disposed on a side of the cover plate disposing the decoration layer.

10. The touch display panel as claimed in claim 9, wherein the display panel is a liquid crystal display (LCD) panel, an organic luminescent display panel, an electronic paper display panel, an electrophoretic display panel, an electrowetting display panel, a bi-stable display panel, or a plasma display panel.

11. The touch display panel as claimed in claim 9, wherein a material of the display-area first bridge lines of each of the first sensing series is a transparent conductive material.

12. The touch display panel as claimed in claim 9, wherein the second sensing series includes a plurality of second sensing pads and a plurality of second bridge lines, the second bridge lines bridge the second sensing pads along the second direction, and a material of the second bridge lines is a transparent conductive material.

13. The touch display panel as claimed in claim 9, wherein the third sensing series includes a plurality of third sensing pads and a plurality of third bridge lines, the third bridge lines bridge the third sensing pads along the second direction, and a material of the second bridge lines is metal.

14. The touch display panel as claimed in claim 9, wherein the display-area first bridge lines, the first sensing pads, and the non-display area first bridge lines of each of the first sensing series are sequentially disposed outwardly from the cover plate.

15. The touch display panel as claimed in claim 9, wherein the display-area first bridge lines and the non-display area first bridge lines of each of the first sensing series are disposed between the first sensing pads and the cover plate.

16. The touch display panel as claimed in claim 9, wherein the display-area first bridge lines and the non-display area first bridge lines of each of the first sensing series are disposed on a side of the first sensing pads away from the cover plate.

17. The touch display panel as claimed in claim 9, wherein the touch panel further comprising a protective layer, covering the first sensing series, the second sensing series, and the third sensing series.
